(19) United States
(12) Patent Application Publication
(10) Pub. No.: US 2017/0173665 A1
(43) Pub. Date: Jun. 22, 2017

(54) Method of Producing a Cooling Channel System for Internal Combustion Engines and Piston Produced in This Way

(71) Applicant: KS Kolbenschmidt GmbH, Neckarsulm (DE)

(72) Inventor: Volker Gniesmer, Alfeld (DE)

(21) Appl. No.: 15/450,347

(22) Filed: Mar. 6, 2017

Related U.S. Application Data
(63) Continuation of application No. 14/607,449, filed on Jan. 28, 2015, now abandoned.
Application No. 14/607,449 is a continuation of application No. 13/811,047, filed on Feb. 13, 2013, now abandoned.

(51) Int. Cl. B21K 1/18; F02F 3/22; F02F 3/00; B23P 15/10

(52) U.S. Cl. CPC B21K 1/185; B23P 15/10; F02F 3/22; F02F 3/003; F02F 2200/00; F02F 2003/0061

(57) ABSTRACT

A method for producing a cooling channel system for an internal combustion engine, which has a cooling channel in the piston crown. The piston crown is adjoined by a lower piston part having a piston boss, pin bores and piston skirts. Firstly, a piston blank having a peripheral collar projecting radially in the region of the piston crown is produced, wherein the collar, forming a subsequent ring zone wall is then reshaped and, in a transition area between the piston crown and the lower piston part, a contact area for the collar is formed, and the collar is reshaped in such a way until the outer radially peripheral edge comes very close to or completely into contact with the contact area in order to form a closed cooling channel. Following the reshaping, the end region of the ring zone wall forms a defined gap (X) with respect to the upper edge of the piston skirt.

### CROSS-REFERENCE TO RELATED APPLICATIONS

This continuation application claims priority benefit to co-pending U.S. patent application Ser. No. 14/607,449 filed Jan. 28, 2015 which is a continuation of U.S. patent application Ser. No. 13/811,047 filed Feb. 13, 2013, now abandoned, the entire contents of both applications are incorporated herein by reference in their entirety.

### BACKGROUND

The disclosure relates to a method for producing a piston and a piston produced by this method.

A method is known from DE 10 2004 031 513 A1 for producing a cooling channel piston for an internal combustion engine that has a cooling channel in its piston crown with an adjoining piston lower part with piston bosses, piston pin bores and piston skirts. Initially a piston blank with a peripheral collar projecting radially in the area of the piston crown is produced and a collar later forming a ring zone wall is then reshaped. Further, a contact area for the collar is formed in a transition zone between the piston crown and the piston lower part and the collar is reshaped until the inner surface of the radially peripheral edge of the collar comes very close to or completely to rest against the contact area in order to form a closed cooling channel in this way. Reference is made herewith in full to the content disclosed in published patent application DE 10 2004 031 513 A1.

Pistons for internal combustion engines are subjected to high inertial forces during operation. Component weight is of ever increasing importance in modern internal combustion engines. Examples are the reduction of drive train forces, reducing friction, etc. The cooling channel piston is subject to severe demands with respect to blow-by and oil consumption, particularly in the ring zone, i.e., in the area of a ring zone wall.

In the generically known method for producing a cooling channel piston, the collar that is provided with ring grooves and thus later forms the ring wall zone is reshaped (folded over) so that the radially peripheral end comes very close to or completely into contact with its inner surface against a contact area of the piston blank. With respect to these steps, reference is made to FIGS. 1 to 4 together with the attendant description of DE 10 2004 031 513 A1. In this, the inner surface of the peripheral lower edge comes to rest against the upper peripheral edge of the piston skirt (the term “lower” and “upper” is to be seen with respect to the axis of the piston stroke). Since the piston blank is normally a piston blank that is produced by forging, it suffers from large tolerances. It cannot be excluded that in the reshaping process the ring wall zone is undesirably deformed, specifically compressed. If the ring wall zone is compressed in the reshaping process, specifically is buckled, the wall remaining behind the ring grooves is deformed uncontrollably in a disadvantageous manner and a potential negative influencing factor on ring function is produced. This means that because of the deformation of the ring wall zone after its reshaping, the rings inserted into the ring grooves are unable to, or are not always able to, perform their required function. Although this generically known piston is improved with respect to its final weight, the requirement of reduced weight still exists for the use of such pistons in modern internal combustion engines.

It would be desirable to provide a method for producing a cooling channel piston that does not present any problems with respect to the rings after production of the piston and during operation in the cylinder of the internal combustion engine and that is further reduced in weight.

### SUMMARY

In accordance with the present method, provision is made for the end area of the ring wall zone to form a defined gap to the upper edge of the piston skirt after reshaping. That is to say, the ring wall zone (the original collar that is reshaped and is given the ring grooves before or after reshaping) forms a defined gap. This gap prevents the ring wall zone from being compressed, specifically upset during and/or after reshaping. The ring zone wall can consequently be freely deformed and the piston blank tolerances can be ignored. By preventing the compression (upsetting) of the ring zone, or the ring zone wall, the wall remaining behind the ring grooves is advantageously prevented from being uncontrollably deformed which would result in a potential negative influencing factor on ring function. Because of this defined gap, the ring zone wall can be intentionally reshaped almost completely or completely to the contact area on the piston blank without interference from projecting ledges on the piston blank. The defined gap is created after reshaping between the lower end of the ring zone wall and the upper, at least partially, specifically completely peripheral upper edge of the piston skirt. In the event of an incomplete radially peripheral piston skirt, the lower end of the ring zone wall can be brought into contact with a correspondingly formed contact area of the piston blank completely or almost completely. The terms “upper” or “lower” edge are to be understood once more with a view to the axis of the piston stroke.

### BRIEF DESCRIPTION OF THE DRAWING

The present method is described and explained below in connection with the following drawing in which:

FIG. 1 is a cross-sectional view of a piston.

### DETAILED DESCRIPTION

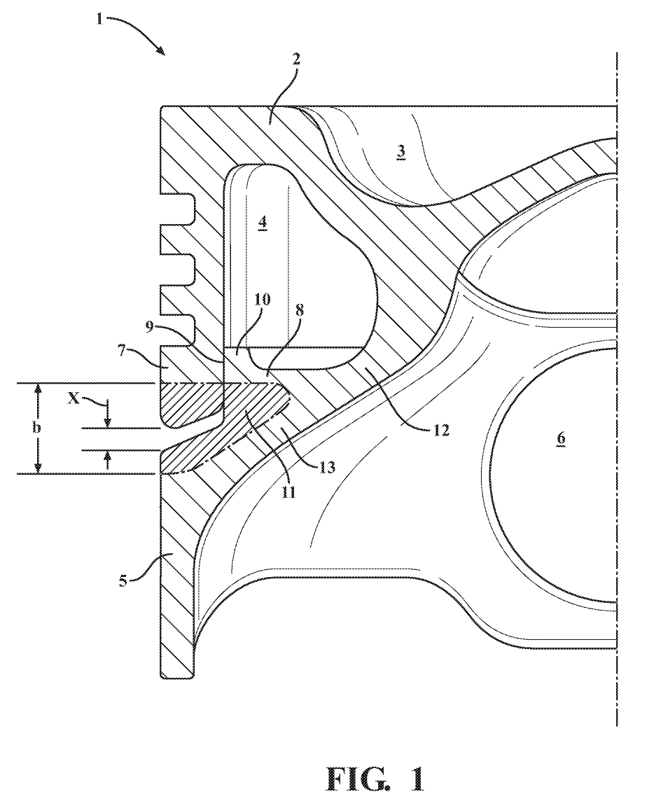

FIG. 1 shows a cooling channel piston 1 that has a piston crown 2. The cooling channel piston 1 may have, but does not have to have, a combustion chamber recess 3. The cooling channel piston 1 shown schematically in FIG. 1 is produced in accordance with the method shown and described in FIGS. 1 to 4 with the attendant description from DE 10 2004 031 531 A1. First there is a projecting collar, wherein the collar is reshaped so that a cooling channel 4 is formed. In addition, the cooling channel piston 1 at this stage of the piston blank has a piston skirt 5 and a piston pin bore 6 that together form the lower part of the cooling channel piston 1. A ring zone wall 7 is formed by the reshaped collar in the area of the piston crown 2. This ring zone wall 7, before or after the reshaping, and, by example, after the reshaping, is provided with an appropriate number of ring grooves (in this case three ring grooves) for example. The contact area on which the collar, that is to say, the later ring wall zone 7, comes to rest on the piston blank, is formed by a cooling channel lower wall 8. That is to say, that a ring zone wall inner surface 9 comes into contact completely or very closely with the radially peripheral end of the cooling channel lower wall 8. Between the upper edge of the piston skirt 5 and the downward pointing radially peripheral edge of the ring zone wall 7, a gap X is left open in order to prevent upsetting of the ring zone wall 7. In this aspect, the contact area is advantageously formed for the ring zone wall 7 by the cooling channel lower wall 8 of the piston blank.

In order to enlarge the contact area of the ring zone wall inner surface 9 against the cooling channel lower wall 8, the cooling channel lower wall 8 is given a step 10 facing in the direction of the cooling channel 4 when the piston blank is produced. This step 10 has another special benefit which will be explained below.

Furthermore, in FIG. 1 an area 11 (shown cross-hatched) can be seen that is removed after the reshaping of the ring wall zone 7. The removal is carried out advantageously by means of a metal-removing process. The following individual steps or combinations are conceivable, whereby the cross-hatched area 11 in FIG. 1 is the result of all three following possibilities. If fewer than three possibilities are implemented, the area 11 appears correspondingly different, specifically smaller.

Firstly, provision is made that after the collar is reshaped and the ring wall zone 7 is taken into its final position, the end of the ring wall zone 7 pointing in the direction of the piston skirt 5 is removed to realize a partial area of area 11. By shortening the length of the ring wall zone 7, material is saved by this cut-in to reduce weight. Supplemental to or as an alternative to this, the edge of piston skirt 5 pointing upward is removed. Weight is also saved by this measure, so that a transition zone 12 in which the piston crown 2 passes into the lower part of the piston forming a skirt connection 13. By removing the upwardly pointing edge of the piston skirt 5, this skirt connection 13 has a required minimum thickness, where this minimum thickness is selected such that adequate strength is given on the one hand to prevent deformation and, on the other hand, material can be removed for weight savings by removing the area 11.

Likewise as a supplemental or alternative measure, part of the piston blank is removed in an area of the skirt connection 13. This means that material is removed in the piston blank not only above the piston skirt 5, but also to the inside (in the direction of the piston pin bore 6) to save additional weight in the cooling channel piston 1 while simultaneously achieving the necessary strength. If material is removed from the piston blank pointing inward in the area of the skirt connection 13, since the cooling channel lower wall 8 is of a relatively thin configuration ,the contact area of the ring zone wall inner surface 9 is enlarged by the step 10. This applies in addition to the moment at which the collar is reshaped so that the ring zone wall 7 is formed and comes to rest against the contact area with its ring wall zone inner surface 8 before the area 11 is removed. Overall, the radially peripheral contact area available for the ring zone wall inner surface 9 is enlarged by the step 10 that points towards the cooling channel 4.

The gap X that results after the reshaping of the collar is enlarged by hollowing out the area 11 in such a way that after the hollowing out process between the lower edge of the ring zone wall 7 and the upper edge of the piston skirt 5, the gap X is enlarged to a dimension b. In addition, the area 11 extends over the thickness of the ring zone wall 7 and/or the thickness of the piston skirt 5 towards the axis of the piston stroke, but does not have to. When designing the collar and thus the subsequent ring zone wall 7, care must be taken that the outer dimension of the collar of the piston blank that is to be reshaped and the location of the upper edge of the piston skirt 5 are selected such that a defined gap X always results after reshaping. This means that through process reliability this gap X must always be large enough that it always results as a gap (consequently does not come into contact with the piston skirt), that the ring zone wall is not upset in the reshaping process (folding process) under any circumstances or otherwise comes into contact with the piston blank (except for the radially peripheral contact against the radially peripheral end of the cooling channel lower wall 8).

Overall, weight reduction, functional improvement of the ring zone and cost savings can be achieved with the method in accordance with the invention. Weight reduction also reduces engine forces, friction is decreased and material is saved. With respect to cost reduction, mention must be made of the savings in operating steps, particularly a welding procedure. Functional improvement can be seen in the advantageous absence of ring zone deformation.

With respect to the welding processing, it should be mentioned that the ring zone wall 7, specifically the ring zone internal wall inner surface 9, can be connected by welding to the peripheral end of the cooling channel lower wall 8 or to the step 10. Since this is certainly possible, but requires an additional procedural step (namely welding), the reshaping process for the collar is particularly advantageously designed so that the ring zone inner surface 9 comes in contact as closely as possible or even completely with the peripheral end of the cooling channel lower wall 8 or of the step 10. If there should be a radially peripheral gap or even only a partial radially peripheral gap remaining, it is so small that the function of the cooling channel 4 is not compromised. For the sake of completeness, reference is made to the fact that between the inner area of the cooling channel piston 1 and the cooling channel 4 at least one opening or two openings is/are introduced, for example, in the transition area 12, in order to ensure an exchange of the cooling medium in the cooling channel 4 in a known way.

1-7. (canceled)

8. A method for producing a cooling channel piston for an internal combustion engine having a cooling channel in a piston crown, wherein a piston lower part with piston bosses, piston pin bores and piston skirts adjoin the piston crown comprising the steps of:
producing a piston blank with a radially projecting and peripheral collar in the area of the piston crown;
reshaping the peripheral collar forming a ring zone wall having a radially distal end and an internal wall inner surface extending from the crown to the distal end;
in a transition zone between the piston crown and the piston lower part, forming a cooling channel lower wall having a radially extending distal contact area;
shaping the peripheral collar by extending the ring zone wall distal end below the cooling channel lower wall and distal contact area until the ring zone wall internal wall inner surface forms a radially outer wall of the cooling channel and comes very closely or completely into contact with the cooling chamber lower wall distal contact area positioned in the cooling channel to form a closed cooling channel; and
reshaping the lower end of the ring zone wall to form a defined gap (X) to an upper edge of the piston skirt.

9. The method for producing a cooling channel piston of claim 8 further comprising:
forming the cooling chamber lower wall distal contact area from the piston blank.

10. The method for producing a cooling channel piston of claim 9 further comprising:
providing the cooling channel lower wall distal contact area with a step extending into the cooling channel during the production of the piston blank.

11. The method for producing a cooling channel piston of claim 8 wherein reshaping the lower end of the ring zone wall further comprises removing a portion of the ring zone wall lower end after the reshaping of the collar.

12. The method for producing a cooling channel piston of claim 8 further comprising:
removing the edge of the piston skirt facing upwards after the reshaping of the collar.

13. The method for producing a cooling channel piston of claim 8 further comprising:
removing a part of the piston blank in an area of a skirt connection after the reshaping of the collar.

14. A cooling channel piston, produced in accordance with the method of claim 8.
